(19) United States
(12) Patent Application Publication
(10) Pub. No.: US 2012/0070226 A1
(43) Pub. Date: Mar. 22, 2012

(54) Insert for Attaching a First Component to a Second Component

(75) Inventor: Yung Ta Su, Taichung City (TW)

(73) Assignee: Bossard AG, Zug (CH)

(21) Appl. No.: 12/883,905

(22) Filed: Sep. 16, 2010

(51) Int. Cl. F16B 5/02; F16B 5/00; F16B 1/00

(52) U.S. Cl. 403/334; 403/404; 403/343

(57) ABSTRACT

The disclosure refers to an insert for attaching a first component to a second component. The insert comprises a body with portions being arranged in the following sequence along a centre line of the insert between two front ends: A first portion with a first diameter; a second portion with a second diameter; a third portion with a third diameter, and a fourth portion with a fourth diameter. The geometries are such that the second diameter is less than the first diameter and less than the third diameter, and the third diameter is less than the first diameter. Finally, the fourth diameter is less than the third diameter. This insert resists increased pull forces when being inserted in the second component

### BACKGROUND OF THE INVENTION

The invention relates to an insert. Inserts typically are used for fastening a first component to a second component via the insert. In a typical scenario the first component is attached to the insert while the insert is pressed into the second component and rests there in a press fit.

However, subject to the application such insert needs to withstand large pull forces.

### BRIEF SUMMARY OF THE INVENTION

Hence, it is a general object of the invention to provide an insert which resists large pull forces.

According to an aspect of the present invention, there is provided an insert for attaching a first component to a second component, the insert comprising a body, the body comprising portions being arranged in the following sequence along a centre line of the insert between two front ends: A first portion with a first diameter; a second portion with a second diameter; a third portion with a third diameter; and a fourth portion with a fourth diameter. The portions are dimensioned such that the second diameter is less than the first diameter and less than the third diameter. The third diameter is less than the first diameter. And the fourth diameter is less than the third diameter.

According to another aspect of the present invention, there is provided an insert for attaching a first component to a second component, the insert comprising a body, the body comprising portions being arranged in the following sequence along a centre line of the insert between two front ends: A first portion with a first perimeter; a second portion with a second perimeter; a third portion with a third perimeter; and a fourth portion with a fourth perimeter. The portions are dimensioned such that the second perimeter is less than the first perimeter and less than the third perimeter. The third perimeter is less than the first perimeter. And the fourth perimeter is less than the third perimeter.

Given the dimensioning it is apparent that the second portion is used as an undercut in the insert which undercut needs to be filled with material of the second component when the insert is pressed into the second component. The second component represents a destination for the insert ending up inserted in the second component in a press fit of sufficient holding force against pull forces. In general, the idea benefits from the insight that the diameter of the third component is smaller than the diameter of the first component. When pressing the insert into its destination the fourth and third portions initially displace material of the second component sideways, i.e. orthogonal to the centre line of the insert which centre line also constitutes the push direction when pressing the insert into the second component. Due to lack of space the displaced material then flows into the undercut built by the second portion at least once the undercut arrives at the level of the second component. When continuing pressing the insert into the second component the undercut will additionally be filled by a flow of material carried away by the first portion once the first portion meets the top level of the second component. Accordingly, the undercut is filled by such flow of material in addition to the flow of material displaced by the fourth and third portion. The material carried away by the first portion is material that was not exposed to the third portion for displacement for the reason that the diameter of the third portion is designed smaller than the diameter of the first portion. Hence, by means of geometry design the undercut is filled by two flows of material which flows are triggered by two different portions of the insert. This enables a substantial filling of the undercut once the final position of the insert in the second component is reached. The filled undercut helps counteracting pull forces in combination with the press fit the other portions of the insert are exposed to.

### BRIEF DESCRIPTION OF THE DRAWINGS

The aspects defined above and further aspects, features and advantages of the present invention can also be derived from the examples of embodiments to be described hereinafter and are explained with reference to examples of embodiments, but to which the invention is not limited. Such description makes reference to the annexed drawings, wherein:

FIG. 1 shows an insert according to an embodiment of the present invention, wherein the respective diagrams illustrate:

FIG. 1a-a plan view on the bottom front end of such insert,

FIG. 1b-a side view of such insert, partially cut open, and

FIG. 1c-a plan view on the top front end of such insert,

FIG. 2 shows an insert according to another embodiment of the present invention, wherein the respective diagrams illustrate:

FIG. 2a—a plan view on the bottom front end of such insert,

FIG. 2b—a side view of such insert, partially cut open, and

FIG. 2c—a plan view on the top front end of such insert.

### DETAILED DESCRIPTION OF THE INVENTION

Inserts may be used for fastening a first component to a second component via the insert. In an advantageous application the first component is attached to the insert while the insert is pressed into the second component and rests there. An advantageous application, for example, is the fastening of a circuit board to a housing wherein the circuit board, e.g. in form of a printed circuit board (PCB) is attached to the insert by means of a screw which screw is fastened into an inside thread of the insert. The insert itself may be pressed into the housing. In a very advantageous embodiment, the insert is used in a mobile phone application in which a circuit board is attached to the housing of the mobile phone made of, e.g. aluminium.

The insert preferably has four portions being arranged along the centre line of the insert. The centre line advantageously corresponds with the axis along which the insert is pressed into the second component. The insert not necessarily consists of these four portions exclusively. There may be additional portions arranged between the individual four portions identified, and there may be different portions arranged between the identified portions and the front ends of the insert. Still, for example, the second portion follows the first portion along the centre line of the insert irrespective if there may be an intermediate portion arranged between the first and the second portion.

Advantageously, the portions in combination may form a single piece insert. However, in alternative embodiments, the individual portions may be fabricated individually and may finally be assembled. In an advantageous embodiment, the insert is a single piece insert and made out of stainless steel. This is very advantageous in particular when the second component into which the insert is to be pressed is made out of aluminium.

A portion with a defined diameter is understood as a portion that shows a minimal height of constant diameter, the minimal height e.g. being at least 0.1 mm. The height of a portion typically is understood as its extension along the centre line.

A lateral extension of a portion, i.e. an extension orthogonal to the centre line, is denoted by the radius or by the diameter of the portion. This may imply a cylindrical shape of such portion. A cylindrical shape of the portions involved certainly is encompassed as an advantageous embodiment, however, the portions may take different shapes.

In case the portions exhibiting a central opening by which e.g. an inside thread is realized, any radius and diameter with respect to such portion is understood as radius or diameter related to the outer periphery of such portion.

Generally, a portion may advantageously be arranged symmetrically with respect to the centre line. However, there may be deviations from such embodiment.

Generally, all portions may take the same basic shape, e.g. all portions may take a cylindrical form. However, there may be deviations from such embodiment.

In another embodiment, the portions are arranged symmetrically around the centre line and all portions are of the same basic shape. For example, the insert may comprise cylindrical portions only varying in diameters such that the portions with larger diameters outrange the portions with smaller diameters along the entire periphery of such portions.

Still, the portions may take basic shapes different to circular cylinders such as e.g. elliptical cylinders. In case of elliptical cylinders, the radius/diameter is interpreted as one of its semimayor axis and its semiminor axis. Basically, the shape of the portions may take any shape of a cylinder with the cross section of such cylinder taking the form of any curve. If the terms radius or diameter may no longer be applied subject to the shape of the portion, it may be beneficial to approach such portion by its perimeter. This may also be true for other basic portion shapes such as prisms, cuboids etc.

Transitions between portions may take different shapes subject to the technical function such transition shall realize. Generally, a transition is described with respect to the transition of the outer periphery of neighbouring portions. Beneficial shapes of such transitions may be steps or slopes.

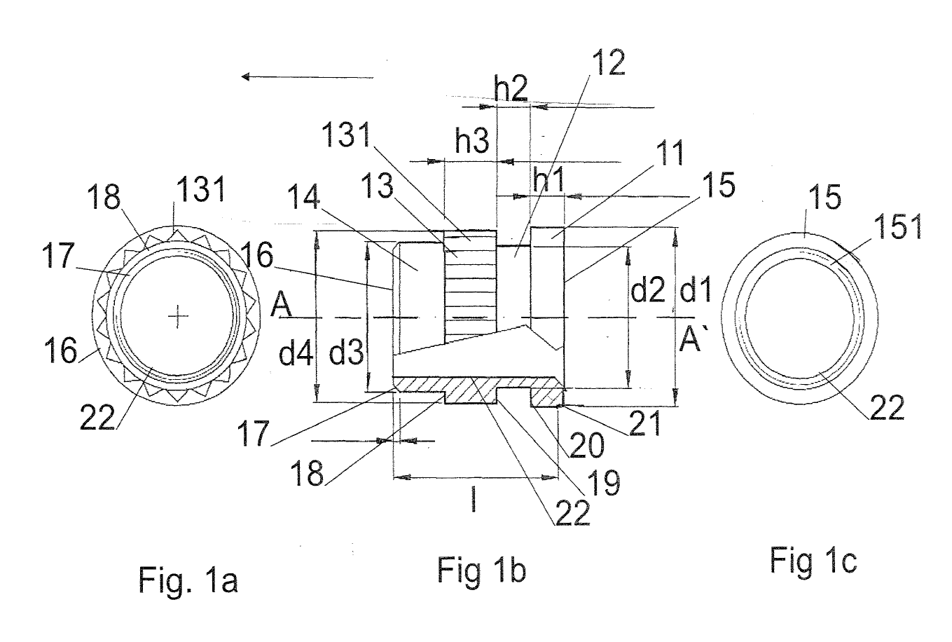

FIG. 1 shows an insert according to an embodiment of the present invention. FIG. 1b illustrates a side view of such insert, partially cut open. The insert 1 comprises a body with four portions 11, 12, 13 and 14. The four portions 11-14 are arranged in a sequel along a centre line A-A′ of the insert 1 between a top front end 15 and a bottom front end 16 of the insert 1. The top front end 15 is represented by a termination of the first portion 11, and the bottom front end 16 is represented by a termination of the fourth portion 14. The insert 1 is made as a single piece element. Diameters of the individual portions 11-14 are generally noted by reference sign d. The first portion 11 has diameter d1, the second portion 12 diameter d2, the third portion 13 diameter d3, and the fourth portion 14 diameter d4. Heights of the individual portions are generally noted by reference sign h. The first portion 11 exhibits height h1, the second portion 12 height h2, the third portion 13 height h3, and the fourth portion 14 height h4. In the present embodiment, the four portions 11-14 in combination form a body of the insert 1. As a result, a length l of the insert 1 is constituted by adding up all the heights h1-h4 of the individual portions 11-14: l=h1+h2+h3+h4.

Transitions of the outer periphery of portions 11-14 are referred to in the drawings. Transition 17 denotes a slope transition at the very end of the fourth portion 14 towards the bottom front end 15. Transition 18 denotes a slope transition between the fourth portion 14 and the third portion 13. Transition 19 denotes a step transition between the third portion 13 and the second portion 12. Transition 20 denotes a transition in form of a step between the second portion 12 and the first portion 11. Transition 21 denotes a transition in form of a slope at the very end of the first portion 11 towards the top front end 15.

From FIG. 1 it can be derived that in the present embodiment the first portion 11 has a diameter d1 which exceeds the diameters of all the other portions 12-14. Diameter d3 of third portion 13 is smaller than diameter d1 but exceeds diameter d2 of the second portion 12. This makes second portion 12 become an undercut in the sequel of portions 11-14 building the body of the insert 1. Diameter d4 of fourth portion 14 is smaller than diameter d3 and slightly smaller than diameter d2.

The partial cut open view indicates that the body of the insert 1 is not fully solid but includes an opening for an inside thread 22. Consequently, in the present embodiment the body of the insert 1 takes the form of a (hollow) cylinder, the cylinder providing different portions 11-14 with different diameters d1-d4 and different kinds of transitions 17-21 at the outer periphery of the insert 1 between the various portions 11-14. The portions 11-14 are aligned along the centre line A-A′. The insert 1 is pressed into its destination component in a direction indicated by an arrow in the drawings. This means that the push direction is parallel to the centre line A-A of the insert 1.

FIG. 1a shows a plan view on the bottom front end 16 of the insert 1 of FIG. 1b which faces the destination component when being pressed into such component. As can be seen from FIG. 1a, the slope of the transition 17 and the step of the transition 18 are visible in this view from underneath as is a pattern at the outer periphery of the third component 13. At its outer periphery, the third portion 13 includes longitudinal cuts with a cross section in form of triangles. It should be noted, that any diameter d3 assigned to the third portion 13 is measured against the protruding elements between the cuts.

The front end 15 denotes the top of the insert 1 on which a pushing force is executed for pressing the insert 1 into the destination component. A plan view on the top front end 15 is illustrated in FIG. 1c. A slim ring representing the top front end 15 is visible in this top view as well as a transition 151 in form of a slope between the top front end 15 and the inside thread 22.

The transition 151 shall alleviate tightening a screw into the inside winding. In the present embodiment, a printed circuit board is attached by means of a screw to the insert. There may be multiple inserts provided to which the printed circuit board may be fastened to by means of screws. The step of fastening a first component such as the printed circuit board to the insert may advantageously be performed after the insert has been pressed into the second component. However, there may be alternative scenarios in which the first component may be fastened first to the insert or to multiple inserts, and the entire construct is then pressed into the second component.

Any insertion process according to the present embodiment involves first touching down the insert 1 by its bottom front end 16 onto the second component. By exerting a force on the top front end 15 of the insert 1 the insert 1 slowly moves into the material of the destination component, i.e. the second component. The slope transition 17 helps in this initial insertion process and displaces material of the second component laterally. Whenever the insert is inserted up to the transition 18 between the fourth and the third component 14 and 13, the pushing force may need to be increased for the reason that the step transition now additionally counteracts any insertion forces. However, subject to the torsion preventing pattern applied to the outer periphery of the third portion 13 the additional resistance to be overcome may be diminished in view of the pattern, e.g. in form of longitudinal cuts, accepting transport of material to be passed on through the pattern.

Once the insert is inserted up to the level of transition 19, the material displaced so far and exercising pressure on the outer periphery of the third portion 13 is offered space in the undercut to flow into. The flow of material into the undercut holds on when further pushing the insert into the material of the second component.

When the transition 20 meets the second component, an additional force has to be applied for further moving the insert 1 into the material of the second component. This is owed to the radial excess length of the first portion 11 compared to the radius of the third portion 13. By this, the first portion 11 generates an additional flow of material into the undercut for the reason that underneath the first portion 11 there still is space for accepting material. On the other hand, the material contributing to the second flow is different to the material contribution to the first flow. The first portion 11 “scrapes” material from sidewalls remaining from the up to now insertion process. The transition 20 in form of a step helps in gathering the material from such side walls. As a result, the undercut is filled sufficiently.

The filled undercut in combination with the press fit of the insert forms an insert which may resist even large pull forces. On the other hand, the cuts 22 in the third portion 13 provide a means against torsion and simultaneously help filling the undercut in that they from transport pipes for the material coming from underneath.

Typically, the insert is pushed into the second component until the top front end 15 is on the same level as the second component. In this position, the insert forms a reliable means for fastening a first component to a second component.

Referring again to the embodiment of FIG. 1, the overall length l of the insert preferably is below 2.5 mm, and specifically may be 2.4 mm, while the first diameter d1 is below 2.5 mm, and specifically may be 2.4 mm. The diameter d2 of the second portion 12, i.e. the undercut, preferably is below 2 mm, and specifically is 1.9 mm while the diameter d3 of the third portion again exceeds the diameter d2 of the second portion 12 and is equal to or below the diameter d1 of the first portion 11. Specifically, the diameter d3 of the third portion is 2.3 mm. The diameter d4 of the fourth portion 14 is advantageously less than the diameter d3 of the third portion 13, and specifically is less than 2.2 mm. Specifically, the diameter d4 may be less than the third diameter d3 and specifically may be 2 mm.

The individual heights of the respective portions which in combination build the overall length l may be dimensioned as follows: Heights h1 and 2 of the first and second portion 11 and 12 respectively may be substantially equal, e.g. 0.5 mm, while the heights h3 and h4 of the third and fourth portion 13 and 14 may exceed. Specifically height h3 may be 0.75 mm, and height h4 may be 0.65 mm. The heights of the present example establish an undercut filling regime in which the material transported to the undercut from underneath, i.e. caused by insertion of the third and fourth portions 13 and 14, exceeds the material transported by the first portion 11.

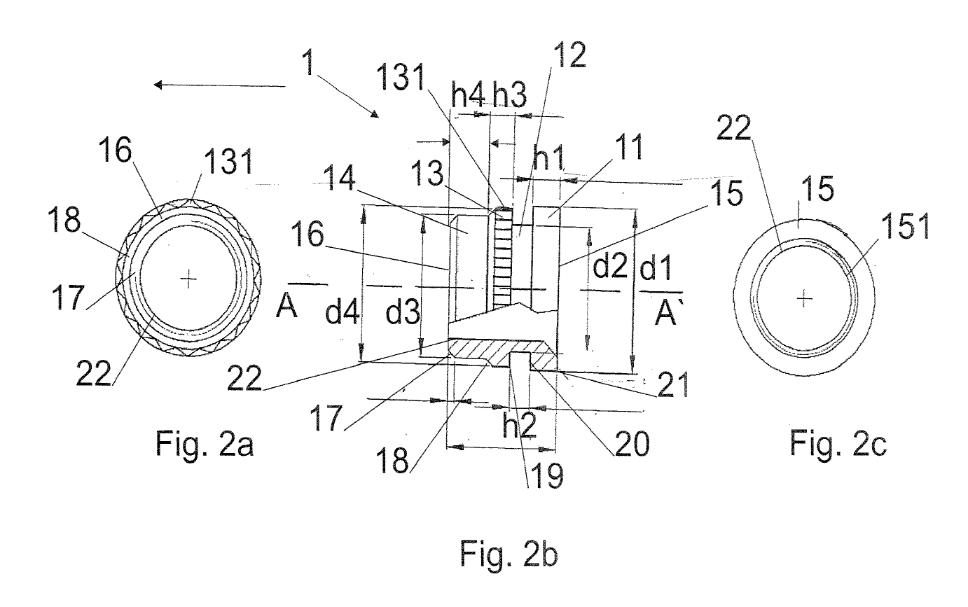

FIG. 2 shows an insert according to another embodiment of the present invention in the respective side, top and bottom plan view. Same elements are referred to by the same reference signs. The insert of FIG. 2 is similar to the insert of FIG. 1. Still, a difference is in that the transition 18 between the fourth and the third portion 14 and 13 now is implemented as a slope instead of a step. The geometries are different in that the present insert 1 is even shorter than the insert 1 of FIG. 1. This insert 1 may have an overall length of not more than 1.7 mm, and specifically of 1.6 mm. This results in different heights of the individual portions 11-14: The main difference is that the height of the third portion 13 not necessarily exceeds the heights of the other portions. Presently, the height h3 of the third portion 13 advantageously is less than 0.4 mm, and specifically is 0.35 mm, while the height h1 of the first portion specifically is 0.4 mm, and the height h2 of the second portion 12 specifically is 0.3 mm. The height h4 of the fourth portion 14 specifically is 0.55 mm.

The first diameter d1 is below 2.3 mm, and specifically may be 2.2 mm. The diameter d2 of the second portion 12, i.e. the undercut preferably is below 2 mm, and specifically may be 1.7 mm while the diameter d3 of the third portion 13 again exceeds the diameter d2 of the second portion 12 and is equal to or below the diameter d1 of the first portion 11. Specifically, the diameter d3 of the third portion 13 is 2.1 mm. The diameter d4 of the fourth portion 14 is advantageously less than the diameter d3 of the third and the first portion 13, 11, and specifically is less than 2 mm. Specifically the diameter d4 may be less than the third diameter d3 and specifically may be 1.9 mm.

While there are shown and described presently preferred embodiments of the invention, it is to be distinctly understood that the invention is not limited thereto but may be otherwise variously embodied and practised within the scope of the following claims.

1. Insert for attaching a first component to a second component, comprising
a body comprising portions being arranged in the following sequence along a centre line of the insert between two front ends
a first portion with a first diameter
a second portion with a second diameter,
a third portion with a third diameter, and
a fourth portion with a fourth diameter,
wherein the second diameter is less than the first diameter and less than the third diameter,
wherein the third diameter is less than the first diameter, and
wherein the fourth diameter is less than the third diameter.

2. Insert according to claim 1, wherein the second diameter is less than the fourth diameter.

3. Insert according to claim 1, wherein a transition of the outer periphery between the first portion and the second portion comprises a step.

4. Insert according to claim 1, wherein a transition of the outer periphery between the third portion and the fourth portion comprises a slope.

5. Insert according to claim 1, wherein a transition of the outer periphery between the fourth portion and the front end associated with the fourth portion comprises a slope.

6. Insert according to claim 1, wherein a transition of the outer periphery between the first portion and the front end associated with the first portion comprises a step.

7. Insert according to claim 1, wherein the first diameter is less than 2.5 mm.

8. Insert according to claim 1, wherein a length of the insert along its centre line is less than 2.5 mm.

9. Insert according to claim 8, wherein a height of the third portion exceeds heights of all the other portions.

10. Insert according to claim 8, wherein a transition of the outer periphery between the second portion and the third portion comprises a step.

11. Insert according to claim 1, wherein a length of the insert along its centre line is less than 1.7 mm.

12. Insert according to claim 11, wherein a height of the fourth portion exceeds heights of all the other portions.

13. Insert according to claim 11, wherein a transition of the outer periphery between the second portion and the third portion comprises a slope.

14. Insert according to claim 1, wherein the outer periphery of the third portion comprises cuts.

15. Insert according to claim 14, wherein the cuts are longitudinal cuts in parallel to the centre line of the insert.

16. Insert according to claim 1, comprising an inside thread for fastening the first component to the insert.

17. Insert according to claim 1, wherein the body of the insert is made of stainless steel.

18. Insert for attaching a first component to a second component, comprising
a body comprising portions being arranged in the following sequence along a centre line of the insert between two front ends
a first portion with a first perimeter,
a second portion with a second perimeter,
a third portion with a third perimeter, and
a fourth portion with a fourth perimeter,
wherein the second perimeter is less than the first perimeter and less than the third perimeter,
wherein the third perimeter is less than the first perimeter, and
wherein the fourth perimeter is less than the third perimeter.
